(19) United States
(12) Patent Application Publication
(10) Pub. No.: US 2010/0060051 A1
(43) Pub. Date: Mar. 11, 2010

(54) FIXING SYSTEM FOR FIXING COVERING MATERIAL

(76) Inventor: Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/449,065

(22) PCT Filed: Feb. 9, 2008
(86) PCT No.: PCT/EP2008/001000

§ 371 Date: Jul. 22, 2009

(30) Foreign Application Priority Data
Mar. 17, 2007 (DE) 10 2007 012 879.9

(51) Int. Cl. A47C 31/02; B68G 7/12

(52) U.S. Cl. 297/218.2

(57) ABSTRACT

The invention relates to a fixing system for fixing covering material to a foam upholstery part of a seat, in particular vehicle or aircraft seat, comprising at least one anchor part that is designed as a profiled body (1) and encapsulated in foam in the upholstery part and a connecting part that can be connected to the covering material, acts in particular as a sewing ply (3) and is fixed to the anchor part along a connection region (7) which runs centrally between profiled side parts (13) in the longitudinal direction of anchor part profile. The profiled side parts lie opposite one another and extend on both sides of the connection region (7). Said system is characterised in that at least one respective channel (15) is formed in both profiled side parts (13), said channel running longitudinally, reducing the cross-sectional surface of the profile and being open on the exterior of the profile.

The invention relates to a fixing system for fixing covering materials to the foam upholstery part of a seat, in particular a vehicle or aircraft passenger seat, with at least one anchoring part which is made as a profiled body and which can be foamed into the foam upholstery part, and a connecting part which can be joined to the covering material, which is used in particular as a sew-on tag, and which is fixed on the anchoring part along one connecting region which runs in the longitudinal direction of the profile of the anchoring part in the middle between the profile side parts which extend opposite one another to either side of the connecting region.

Fixing systems of this type are known, see DE 103 03 358 A1. In the production of such a fixing system the profile body is extruded from an extrudable plastic material as a one-piece monoextrudate, an essentially solid, strip-like body being formed which is conventionally also referred to as a “piping profile” in the jargon. To form the connecting region for fixing the connecting part which is conventionally used as a sew-on tag, the back of the profile body, i.e., the side which faces the covering material, is provided with a slot-like receiving opening which runs in the longitudinal direction of the profile, in which the connecting part (sew-on tag) made as a connecting strip is attached.

In the production of these systems, difficulties arise both in conjunction with the actual extrusion of the profile body and also the embedding of the sew-on tag into the receiving slot. With respect to embedding the sew-on tag, instead of the formerly conventional bonding or adhesive connections, intrusion processes have proven more favorable in which between the plastic material of the profile body and the plastic material of the sew-on tag a high-strength connection is formed by mutual, positive embedding of the materials. The basic prerequisite for this is, however, that both the extrusion process of the profile body and also the embedding of the sew-on tag are thermally controlled with high precision. As has been shown, difficulties, however, arise in keeping the material temperatures at the setpoint over the entire cross sectional region over the time intervals important for the process, since cooling rates differ greatly in various regions.

Different cooling rates are disadvantageous not only with respect to the embedding of the sew-on tag, but are also disruptive to the actual extrusion process of the profile body and are therefore also disadvantageous when the sew-on tag is embedded, not by an intrusion process, but in the conventional manner by a bonding or adhesive connection.

The object of the invention is to make available a fixing system in whose production the aforementioned difficulties are avoided.

According to the invention this object is achieved by a fixing system which has the features of claim 1 in its entirety.

Accordingly, one important feature of the invention consists in that the profile body is made such that in the two profile side parts at least one channel at a time is formed which is open on the outside of the profile, which reduces the profile cross sectional area, and which runs in the longitudinal direction. Differently than in a solidly made profile body, by the corresponding dimensioning and position arrangement of the channels the profile thickness, in particular in the region bordering the receiving slot, can be reduced in a controlled manner such that in the course of extrusion and embedding of the sew-on tag the desired uniform cooling rates arise.

Preferably, the cross sections of the profile side parts are identical in mirror image, i.e., in both profile side parts there are channels shaped identically to one another, symmetrically to the axis of the receiving slot.

Furthermore, the arrangement can be advantageously made such that each profile side part has a primary anchoring surface which extend proceeding from the connection region transversely to the direction of the tensile force which can be transferred by way of the sew-on tag and whose outer ends define the greatest profile width.

A profile shape in which the primary anchoring surfaces each have one minor, axially parallel concave arch has proven especially favorable.

Preferably each profile side part is divided into two profile side arms at a time by one channel each.

For a profile shape which is favorable with respect to extrusion and embedding of a favorable profile shape, the channels between the channel base and outside channel mouth run obliquely such that the channel base is nearest the primary anchoring surface and the connecting region, while the channel mouth has a greater distance from the primary anchoring surface.

In this connection the arrangement can be made such that the channels each have one flat channel side surface and one convexly arched channel side surface, the arched channel side surface being adjacent to the primary anchoring surface.

Anchoring behavior is especially good when the profile side arms on the edges of the channel mouth each form a projecting anchoring rib which runs in the longitudinal direction of the profile and which is rounded in cross section in the manner of a circular arc.

The invention especially advantageously makes it possible to provide a line for flowable media in at least one channel or provide one or more channels as a guide for at least one electrical conductor. Such embodiments are especially suited for seat systems in whose upholstery parts cooling or heating systems are integrated or in which electrical lines for communications system, control system or drive systems can be installed.

To the extent the designation “sew-on tag” is used in the specification and in the claims to describe the connecting part between the upholstery covering material and the foam upholstery part, it is not considered critical that the covering material, for example, in the form of a cushion covering material of a vehicle seat, be sewn to the sew-on tag, but rather the pertinent connection can also be produced by way of cements, thermal bonding or the like.

The invention is detailed below using the drawings.

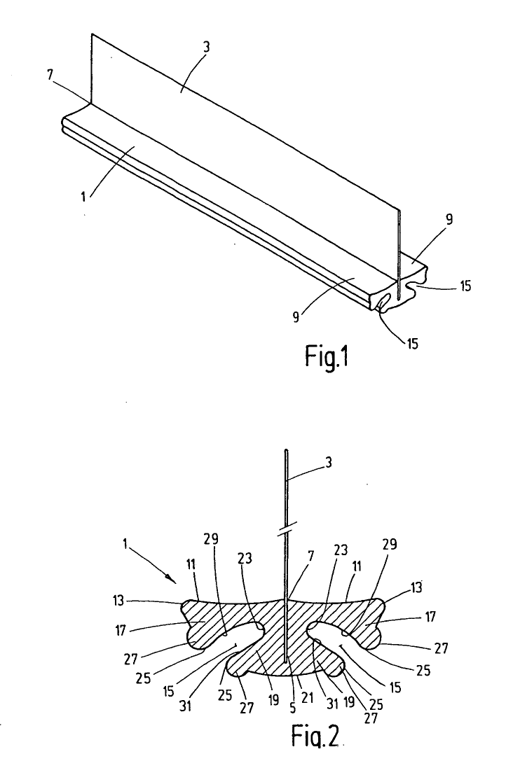

FIG. 1 shows a perspective oblique view of one embodiment of the fixing system according to the invention, enlarged by approximately 1.5 times compared to the practical embodiment;

FIG. 2 shows a cross section of the embodiment enlarged compared to FIG. 1;

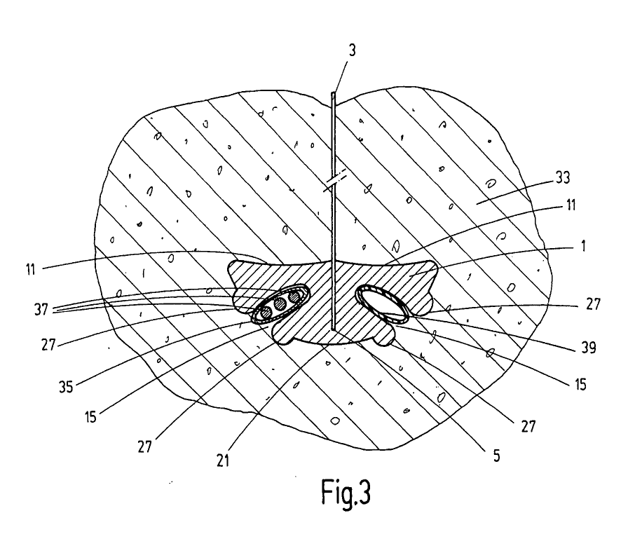

FIG. 3 shows the cross section shown in FIG. 2, foamed into a schematically shown foam upholstery part of a seat, the channels in the profile body which is used as the anchoring part being used as guides for lines for flowable media and for electrical conductors.

In the figures, a profile body which is used as the anchoring part is designated as 1 and a sew-on tag which is used as the connecting part and which is fixed on the profile body is designated as 3. The profile body 1 is extruded as a monoextrudate from a soft polyvinyl chloride material (PVC) or from a polypropylene block copolymer. The sew-on tag 3 consists of a nonwoven material, for example, of a polyester or of an open-pore network system, such as a knit or woven textile. In these materials it is possible to implement a high-strength connection between the profile body 1 and sew-on tag 3 by thermal intrusion by the plasticized plastic material of the profile body penetrating into structure spaces such as the lattice structure of the sew-on tag and hardening when cooled, so that a positive connection is formed. For this purpose, in the profile body 1 a receiving slot 5 is formed for the end edge of the sew-on tag 3, the slot 5, placed in the middle in the profile body 1, defining a connecting region 7 which runs in the longitudinal direction of the profile.

The profile body 1 is made symmetrical to the axis of the receiving slot 5 so that two profile side parts 9 (FIG. 1) which are shaped identically in mirror image are formed. On the profile back, from which the sew-on tag 3 extends away, the two profile side parts 9 form one primary anchoring surface 11 each which is not completely plane in the illustrated example, but has a slightly axially parallel running concave arch. The outer end edges 13 of the primary anchoring surfaces 11, which edges are rounded in the shape of an arc, define the greatest profile width of the profile body 1.

In each of the profile side parts 9 a channel 15 is made such that each profile side part 9 is divided into one profile arm 17 adjacent to the primary anchoring surface 11 and one profile arm 19. The channels 15 have a channel width which is approximately one third of the profile height of the profile body 1 between the primary anchoring surfaces 11 and the profile end surface 21 opposite it. While the primary anchoring surfaces 11 are arched to be slightly concave, the profile end surface 21 has a slight convex arch.

The channels 15 are oriented such that the channel base 23 is nearest the primary anchoring surfaces 11 and the connecting region 7, while the edges 25 of the channel mouth 25 are offset obliquely to the outside and down against the end surface 21. On all edges 25 of the mouth there is one projecting anchoring rib 27 at a time which runs in the longitudinal direction of the profile and which is rounded in cross section in the shape of a circular arc.

Of the channel side walls, the side wall 29 adjacent to the primary anchoring surface 11 is concavely arched, while the other side wall 31 is flat. The profile width of the profile body 1 which is defined by the end edges 13 of the primary anchoring surfaces 11 in the illustrated example is somewhat more than twice the profile height between the profile end surface 21 and the primary anchoring surfaces 11.

FIG. 3, in which by virtue of agreement with FIG. 2 not all details are numbered, shows the embodiment embedded in a foam upholstery part 33 of a seat which is not shown. The foam upholstery part 33 can be a foam material (PU foam material) which is conventional for these applications. FIG. 3 illustrates that the channel 15 located on the left side in the drawings is used as a guide for electrical conductors 37 which are located in a foam-tight jacket 35 and which are part of an electrical system integrated into the seat system. The channel 15 located on the right side in FIG. 3 is used as a guide for a tube-like pipeline 39 which can be a component of a heating or cooling system integrated into the seat system or which can be used as a compressed air line for pneumatic positioning means in the seat system.

1. A fixing system for fixing of covering materials to a foam upholstery part (33) of a seat, in particular a vehicle or aircraft passenger seat, with at least one anchoring part which is made as a profiled body (1) and which can be foamed into the foam upholstery part (33), and a connecting part which can be joined to the covering material, which is used in particular as a sew-on tag (3), and which is fixed on the anchoring part along one connecting region (7) which runs in the longitudinal direction of the profile of the anchoring part in the middle between the profile side parts (9) which extend opposite one another to either side of the connecting region (7), characterized in that in the two profile side parts (9) at least one channel (15) is formed which is open on the outside of the profile, which reduces the profile cross sectional area, and which runs in the longitudinal direction.

2. The fixing system according to claim 1, characterized in that the cross sections of the profile side parts (9) are identical in mirror image,

3. The fixing system according to claim 2, characterized in that each profile side part (9) has a primary anchoring surface (1) which extends proceeding from the connecting region (7) transversely to the direction of the tensile force which can be transferred by way of the sew-on tag (3) and whose outer ends (13) define the greatest profile width.

4. The fixing system according to claim 3, characterized in that the primary anchoring surfaces (11) each have a minor, axially parallel concave arch.

5. The fixing system according to claim 1, characterized in that each profile side part (9) is divided into two profile side arms (17 and 19) at a time by one channel each (15).

6. The fixing system according to claim 5, characterized in that the channels (15) between the channel base (23) and outside channel mouth run obliquely such that the channel base (23) is nearest the primary anchoring surface (11) and the connecting region (7) and the channel mouth has a greater distance from the primary anchoring surface (11).

7. The fixing system according to claim 6, characterized in that the channels (15) each have one flat channel side surface (31) and one convexly arched channel side surface (29) and that the arched channel side surface (29) is adjacent to the primary anchoring surface (11).

8. The fixing system according to claim 5, characterized in that the profile side arms (17, 19) on the edges (25) of the channel mouth each form a projecting anchoring rib (27) which runs in the longitudinal direction of the profile and which is rounded in cross section in the manner of a circular arc.

9. The fixing system according to claim 8, characterized in that the distance between the anchoring ribs (27) which border the flat channel side surface (31) corresponds approximately to half the total profile width.

10. The fixing system according to claim 1, characterized in that there is a line (39) for flowable media in at least one channel (15).

11. The fixing system according to claim 10, characterized in that there is a line (39) through which a coolant or heating medium flows.

12. The fixing system according to claim 1, characterized in that at least one channel (15) forms a guide for at least one electrical conductor (37).
